(19) United States
(12) Patent Application Publication
(10) Pub. No.: US 2026/0178768 A1
(43) Pub. Date: Jun. 25, 2026

(54) UTILIZING AN EAGER EVALUATION MODEL FOR ATTRIBUTE-BASED ACCESS CONTROLS WITHIN A MULTI-TENANT ENVIRONMENT

(71) Applicant: OneTrust LLC, Atlanta, GA (US)

(72) Inventors: Abhishek Mishra, Atlanta, GA (US); Jayarama Nalka, Kasaragod (IN); Alok Mishra, Bengaluru (IN); Samuel Frank, Chicago, IL (US); Jacqueline Dane, Atlanta, GA (US); Stephen Roca, Snellville, GA (US); Sindhura Gade, Cumming, GA (US)

(21) Appl. No.: 18/988,655

(22) Filed: Dec. 19, 2024

(51) Int. Cl. G06F 21/62

(52) U.S. Cl. CPC G06F 21/6227

(57) ABSTRACT

Methods, systems, and non-transitory computer readable storage media are disclosed for implementation of executing operations with one or more hardware processors to access a tenant database within a multi-tenant environment and generate mapping records for one or more user accounts and one or more objects by executing an eager evaluation model in response to creation of an access policy. The disclosed systems generate policy subject mappings mapping the access policy to user accounts based on attributes of the user account and policy object mappings mapping the access policy to objects according to the attributes of the objects. Upon receiving a request from a user account to access an object within the tenant database, the disclosed systems provide access to the one or more objects based on the policy subject mappings, the policy object mappings, and attributes of the user account.

### BACKGROUND

Advances in computer processing and data storage technologies have led to a significant increase in the amount and types of data moved to digital environments for processing. Specifically, many entities utilize computing devices and/or software applications to store, analyze, and/or perform a number of computing operations on different types of data. Computing systems handling (e.g., collecting, receiving, transmitting, storing, processing, sharing, and/or the like) certain types of digital data are often subject to handling such data in a compliant manner according to different regulations or frameworks. More specifically, many data processes for handling data are subject to various laws, regulations, and industry standards that include requirements for handling such types of data in specific ways (e.g., via certain computing processes, limitations, or capabilities) for security and privacy reasons.

In connection with handling digital data, entities often control access to digital data by utilizing attribute-based access controls (ABAC), which utilizes attributes of user accounts and digital data to determine which users can access specific digital data. Some existing systems utilize an eager evaluation approach of the ABAC by evaluating the access policies of the ABAC upon creation of a set of controls (e.g., ahead of time prior to receiving requests to access digital data). However, existing systems struggle to implement the eager evaluation approach within the ABAC framework in connection with multi-tenant environments because they are not able to properly isolate or secure data for different tenants within the multi-tenant environment. For example, existing systems do not support the ABAC framework employing eager evaluation for each tenant within the multi-tenant environment while allowing each tenant within the multi-tenant environment to store their data in their own (or tenant specific) database.

Additionally, some existing systems utilizing eager evaluation for their ABAC framework suffer from computing and storage inefficiencies. For example, existing systems generate access control lists (ACLs) that map user accounts to objects (or data). Thus, based on the number of objects and number of users, some existing systems can generate hundreds of thousands or millions of mapping records or ACLs. For example, existing systems mapping 1,000 users to 1,000 objects must employ vast amounts of computing resources to generate 1,000,000 mappings. Moreover, such existing systems must further tap into computing resources to detect, manage, and update the 1,000,000 mappings. Additionally, some conventional systems employ a large number of computing resources comparing an access policy against all of the objects associated with the tenant in response receiving a request from a user account to access multiple objects. Thus, some conventional systems employ inefficient processes to determine if a user account can access multiple objects. Relatedly, such existing systems also use large amounts of memory to store all of the mappings (or ACLs) due to the large number of mappings. Indeed, conventional systems typically use processes that fail to adequately secure data via an ABAC framework in a multi-tenancy environment or to efficiently implement an ABAC framework within a multi-tenancy environment.

### SUMMARY

This disclosure describes various aspects for utilizing attribute-based access controls (ABAC) with an eager evaluation approach within a multi-tenant environment by using various mappings with an access policy. For example, the disclosed systems execute operations with one or more hardware processors that access a tenant database within a multi-tenant environment to generate mapping records for one or more user accounts and one or more objects by executing an eager evaluation model in response to a creation of an access policy. In particular, the disclosed systems generate (i) policy subject mapping(s) that maps the access policy to one or more user accounts based on features or attributes of the one or more user accounts, and (ii) policy object mapping(s) that maps the access policy to one or more objects according to the features or attributes of the one or more objects. The disclosed systems thus generate indirect mappings between the user account(s) and the object(s) via the mappings with the access policy. In some cases, upon receiving a request from a user account to access the one or more objects within the tenant database, the disclosed systems provide access to the one or more objects based on the policy subject mapping(s), the policy object mapping(s), and one or more attributes of the user account(s) and/or one or more attributes of the object(s).

### BRIEF DESCRIPTION OF THE DRAWINGS

Various embodiments will be described and explained with additional specificity and detail through the use of the accompanying drawings.

FIG. 1 illustrates an example of an overview of an access permission management system utilizing an eager evaluation approach for attribute-based access controls within a multi-tenant environment in accordance with one or more embodiments.

FIG. 2 illustrates an access permission management system generating mapping records corresponding to an access policy in accordance with one or more embodiments.

FIG. 3 illustrates an access permission management system linking to a tenant database for attribute-based access controls within a multi-tenant environment in accordance with one or more embodiments.

FIG. 4 illustrates an access permission management system utilizing an access policy administration server, an access policy enforcement server, and an access policy decision server to determine access to one or more objects for one or more user accounts in accordance with one or more embodiments.

FIG. 5 illustrates an example of an access permission management system receiving shared direct access and/or shared direct revocation of access to an object from a user account based on an access policy in accordance with one or more embodiments.

FIG. 6 illustrates an example of a graphical user interface for generating an access policy in accordance with one or more embodiments.

FIG. 7 illustrates an example of a graphical user interface for reviewing and activating an access policy in accordance with one or more embodiments.

FIG. 8 illustrates an example of a graphical user interface for providing direct access to one or more objects or directly revoking access to one or more objects for one or more user accounts in accordance with one or more embodiments.

FIG. 9 illustrates an example of a graphical user interface for modifying default access policies for one or more objects in accordance with one or more embodiments.

FIG. 10 illustrates an example flowchart of a method for determining access of one or more user accounts to one or more objects using mappings via an access policy in accordance with one or more embodiments.

FIG. 11 illustrates an example of a system environment in which an access permission management system can operate in accordance with one or more embodiments.

FIG. 12 illustrates an example of a computing device in accordance with one or more embodiments.

### DETAILED DESCRIPTION

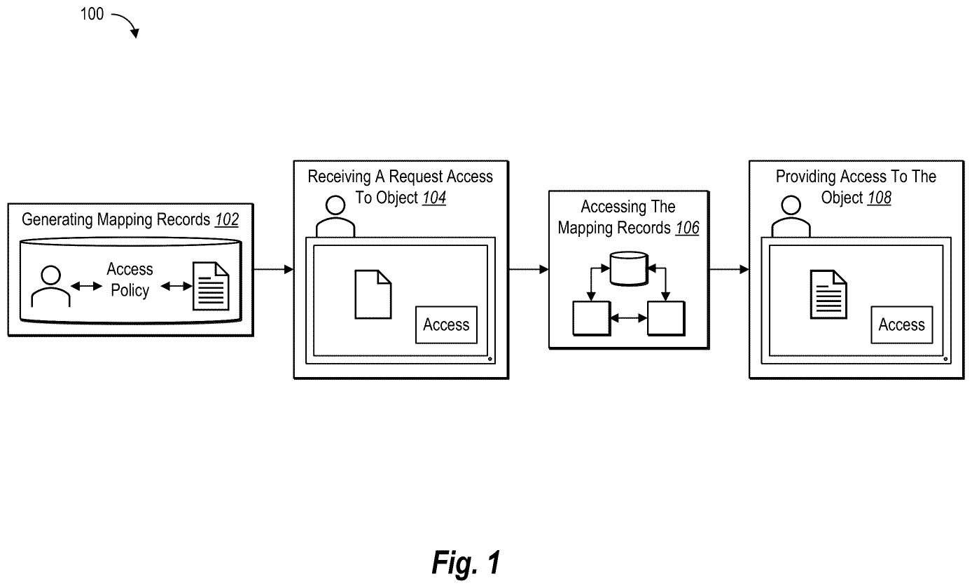

This disclosure describes one or more embodiments of an access permission management system that utilizes an eager evaluation model (or eager evaluation) to evaluate access policies defining access for user accounts to objects stored in a tenant database that exists within a multi-tenant environment. Specifically, the access permission management system utilizes indirect mappings between objects (e.g., representing digital data containers) and user accounts utilizing an access policy to provide secure and accurate attribute-based access controls in multi-tenant environments. FIG. 1 illustrates an example of an overview of an access permission management system 100 utilizing an eager evaluation approach for attribute-based access controls within a multi-tenant environment in accordance with one or more embodiments.

As shown in FIG. 1, the access permission management system 100 performs an act 102 of generating mapping records. In particular, the access permission management system 100 can generate mapping records between an access policy and one or more objects and/or between the access policy and one or more user accounts associated with a tenant and corresponding tenant database. Once the access permission management system 100 detects a creation (or activation) of the access policy, the access permission management system 100 can execute an eager evaluation model to generate (i) a policy subject mapping that maps the access policy to one or more user accounts according to one or more attributes of the one or more user accounts, and (ii) a policy object mapping that maps the access policy to the one or more objects according to one or more attributes of the one or more objects. Indeed, the access permission management system 100 can utilize the eager evaluation model to immediately assess the access policy and/or changes to the access policy based on changes to one or more objects and/or one or more user accounts.

As further shown, in FIG. 1, once the access permission management system 100 performs the act 102 of generating mapping records, the access permission management system 100 performs an act 104 of receiving a request for access to an object. In particular, the access permission management system 100 can receive, from a user account, a request for access to read, edit, share, or otherwise interact with the one or more objects within the tenant database.

As mentioned above, the access policy can include mapping records (or policy subject mappings) connecting (or associating) the access policy to one or more user accounts. For example, the access permission management system 100 can generate and utilize an indirect access control list (ACL) to associate a user account with the access policy. Additionally, in some cases, the access permission management system 100 can utilize the mapping records to determine if the user account has access to the one or more objects (e.g., based on policy object mappings linking the access policy to the one or more objects).

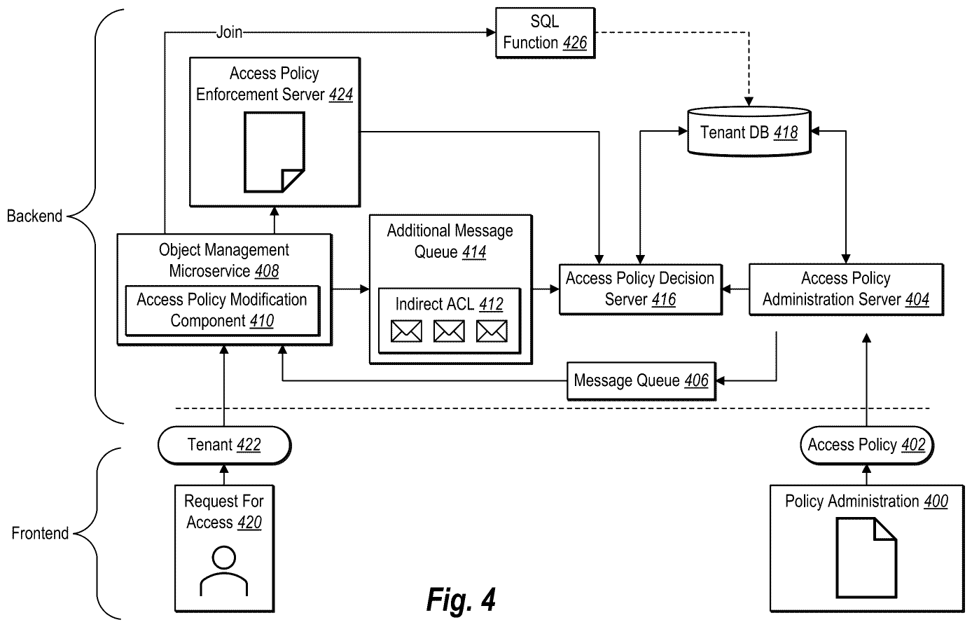

As shown in FIG. 1, the access permission management system 100 can perform the act 106 of accessing the mapping records. In particular, the access permission management system 100 can utilize various hardware processors and/or servers communicating with each other to access from a specific tenant database within a multi-tenant environment, the access policy, policy subject mappings, and/or policy object mappings to determine if the user account has access to the one or more objects. For example, as discussed in more detail below in FIG. 4, the access permission management system 100 can utilize an ABAC framework comprising an access policy administration server, access policy enforcement server, and access policy decision server to evaluate the request to access an object. Moreover, the access permission management system 100 can utilize a tenant context to securely link the ABAC framework to the appropriate tenant database.

As indicated above, the access permission management system 100 can provide or deny access of one or more content items to one or more user accounts according to an access policy. As FIG. 1 further illustrates, the access permission management system 100 can perform the act 108 of providing access of the object to the user account. In particular, based on the access policy, policy subject mapping, the policy object mapping, and the one or more attributes of the user account, the access permission management system 100 can provide access to read, edit, and/or otherwise interact with the object. For example, the access permission management system 100 can allow the user account to edit the object based on the one or more attributes of the user account corresponding to the attributes (or characteristics) outlined by the policy subject mapping and the attributes (such as level of risk or level of severity) corresponding to the policy object mapping.

As illustrated by the foregoing discussion, the present disclosure utilizes a variety of terms to describe the features and benefits of the access permission management system 100. Additional detail is hereafter provided regarding the meaning of these terms as used in this disclosure. For example, as used herein, the term “tenant database” refers to database, index, or data bank that stores data, objects, or information related to a single tenant. In some cases, a tenant database can store access policies and mapping records associated with the tenant. For example, the tenant database can store policy subject mappings, policy object mappings, shared direct access, shared direct revocation of access, and/or indirect access control lists. Indeed, in one or more embodiments, the tenant database can secure and isolate the data (e.g., objects) of one tenant from another tenant. Relatedly, as used herein, the term “tenant” refers to an, individual, group, organization, entity, or group of individuals that share access to a software application or software instance. For example, a tenant can be an organization that shares the same data and/or database in a cloud storage environment. In some cases, a tenant can be an organization comprising multiple groups or individuals. For example, a tenant can be a company comprising an auditing group, quality control group, marketing group, etc.

Additionally, as used herein, the term “multi-tenant environment” refers to an environment where an application, software architecture, or cloud infrastructure services multiple tenants. For example, in some cases, a multi-tenant environment can be an SQL server database where each tenant within the multi-tenant environment (SQL server database) has their own database. As described in more detail below, the access permission management system 100 can dynamically connect to a tenant database while evaluating access policies and accessing mapping records associated with each tenant.

As used herein, the term “access policy” refers to a set of rules or conditions managing how user accounts associated with a tenant (e.g., entity) access data associated with the tenant. In particular, the set of rules associated with the access policy are based on one or more attributes of the user account(s) and the object(s). In some implementations, an access policy can outline which user accounts can access objects stored in the tenant database and when a user account can access objects within the tenant databased. In one or more embodiments, an access policy can dictate which permissions (or actions) a user account can perform on objects and/or up to which risk (or level) a user account can access objects within the tenant database.

As used herein, the term “policy subject mapping” refers to a mapping that associates attributes of user accounts to an access policy. For example, in one or more embodiments, a policy subject mapping can reflect which user accounts can or cannot access one or more objects associated with the access policy based on attributes associated with a user account as outlined by the access policy. Relatedly, the term “policy object mapping” refers to a mapping that associates attributes of an object to an access policy. For example, an object may have an attribute indicating that it has a critical risk level. The policy object mapping can associate the object with the access policy based on the critical risk level of the object. Thus, attribute-based access controls indicate access to objects by certain user accounts based on the attributes of the user accounts and/or objects as indicated in an access policy via policy subject mappings and policy object mappings.

Moreover, as used herein, the term “user account” refers to an account (or subject) associated with a user that accesses a computing system, application, and/or database. In one or more embodiments, a user account can be associated with a tenant (or entity). Moreover, a user account can be associated with one or more attributes. For example, one or more attributes of a user account can include, but are not limited to: title, user identification, e-mail, role, location, network data (e.g., IP address), device(s), access levels, clearance, tenure, department, responsibilities, and/or position.

As used herein, the term “object” refers to digital data, a digital asset, or a digital process. In some cases, an object can include digital files, databases, networks, domains, and/or software applications or tools and can be associated with a tenant. For example, an object can be a report generated within an application supported by the tenant. As another example, an object can be an endpoint of an application programing interface (API). In some cases, an object can have one or more attributes indicating the type, level of risk, creation date, owner, modification dates. For example, in one or more embodiments, an object can correspond to a high level of risk or a low level of risk. Accordingly, as indicated above, the access permission management system 100 can control access to one or more objects stored within a tenant database based on the one or more attributes of object (e.g., the level of risk associated with the object).

As indicated, the access permission management system 100 provides a number of advantages over conventional systems. For example, the access permission management system 100 provides improved security and efficiency to computing systems that utilize an eager evaluation approach toward attribute-based access controls within a multi-tenant environment. In particular, unlike existing models that are unable to segregate tenant specific data into separate tenant databases in ABAC frameworks, the access permission management system 100 can provide each tenant with their own tenant database within the multi-tenant environment and securely link an ABAC framework employing an eager evaluation model to the tenant database when receiving a request from a user account associated with the tenant to access one or more objects within the tenant database. For example, the access permission management system 100 can receive, from a client device associated with a user account associated with a tenant, a request to access an object within a tenant database. In some cases, the access permission management system 100 can generate a tenant context associated with the tenant and utilize the tenant context to connect the ABAC framework to the tenant database. Thus, the access permission management system 100 can securely isolate tenant data within individual tenant databases and employ the ABAC framework executing an eager evaluation model by leveraging an indirect mapping structure linking user accounts and objects via an access policy.

Additionally, many conventional systems are inefficient because, as described above, they generate, monitor, and store an inordinate number of mappings between objects and user accounts (or subjects). Unlike such conventional systems, the access permission management system 100 can generate mapping records (or indirect ACLs) that map (i) user accounts (or subjects) to an access policy, and (ii) objects to the access policy, which thus indirectly links the user accounts to the objects via the access policy. Thus, the access permission management system 100 generates fewer mappings than conventional systems, resulting in significantly less resource usage (e.g., less data storage and processing resources). For example, an access policy granting access for 1000 user accounts to 1000 objects would generate 2001 total mapping records for the access policy. Accordingly, the access permission management system 100 stores the 2001 total mapping records for the access policy as compared to conventional systems that would otherwise generate and store 1,000,000 mappings for an access policy applied to 1000 user accounts and 1000 objects.

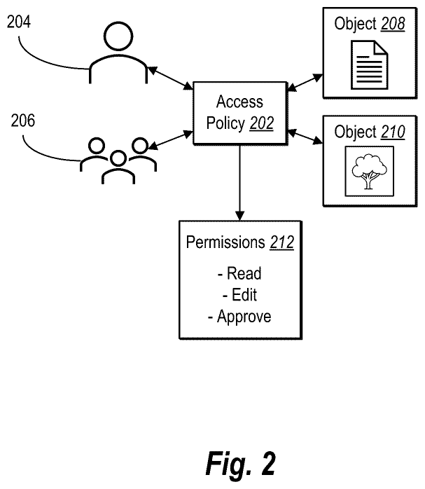

As indicated above, the access permission management system 100 can eagerly (or dynamically) evaluate a newly created access policy upon creation of the access policy. Accordingly, FIG. 2 illustrates an access permission management system 100 generating mapping records based on one or more rules (or conditions) corresponding to an access policy in accordance with one or more embodiments. As mentioned above and shown in FIG. 2, the access policy 202 can include a set of rules or conditions to apply to various user accounts (e.g., user account 204 and/or a group of user accounts 206) and/or objects 208, 210. Accordingly, the access permission management system 100 can execute an eager evaluation to instantly assess the set of rules associated with the access policy to generating mapping records for the access policy. For example, the access policy 202 can indicate that certain set of user accounts (e.g., user accounts with C-suite roles) can access a certain set of objects with a critical risk status. Accordingly, the access permission management system 100 can execute the eager evaluation model to generate mapping records between the user accounts with C-suite roles with the access policy 202 and the set of objects with the critical risk status with the access policy 202.

As just indicated, once the access permission management system 100 receives a creation of the access policy 202, the access permission management system 100 can execute the eager evaluation model on the access policy 202 to generate mappings (or mapping records) between (i) the access policy 202 and user accounts, and (ii) the access policy 202 and objects. For example, the access permission management system 100 can generate an access policy identification associated with the access policy 202 and map the access policy 202 to the user account 204 and/or the group of user accounts 206 by associating (or linking) the access policy identification to the user account 204 and/or the group of user accounts 206. Likewise, the access permission management system 100 can map the access policy 202 by linking (or connecting) the access policy identification associated with the access policy 202 to the objects 208, 210.

In one or more embodiments, the mapping records can include a policy subject mapping. In particular, the access permission management system 100 can generate a policy subject mapping that maps the access policy 202 to the user account 204 and/or the group of user accounts 206 based on one or more attributes associated with the user account 204 or the group of user accounts 206. In some cases, one or more attributes associated with the user account 204 and/or the group of user accounts 206 can include, but are not limited to, title, user identification, e-mail, role, age, location, network data (e.g., IP address), device(s), access levels, environment, circumstance, clearance, tenure, department, responsibilities, and/or position with an organizational hierarchy of the tenant (or entity) corresponding to the user account 204 and/or the group of user accounts 206.

Indeed, the access permission management system 100 can identify and utilize the one or more attributes of the one or more user accounts associated with the tenant to generate the policy subject mappings between the one or more user accounts and the access policy 202. For example, the access permission management system 100 can identify the clearance, department, and role of the user account 204 and generate the policy subject mapping between the access policy 202 and the user account 204 based on the clearance, department, and role of the user account 204 and the clearance, department, and role outlined by the access policy 202.

As further shown in FIG. 2, the access permission management system 100 can generate mappings between the access policy 202 and the objects 208, 210. As described above, the access permission management system 100 can generate policy object mappings that map the access policy identification of the access policy 202 to the objects 208, 210 stored in a tenant database based on the one or more attributes of the objects 208, 210. For example, the access permission management system 100 can identify one or more attributes of the one or more objects 208, 210. In some cases, the one or more attributes of the objects 208, 210 can include, but are not limited to, levels of risk, privacy, severity, and/or security, status (e.g., open, closed), labels, creation date, edit dates, owner, association, and/or type.

For example, the access permission management system 100 can identify that the objects 208, 210 are risk objects corresponding to a critical risk level. Based on the critical risk level of the objects 208, 210, the access permission management system 100 can generate (i) a first policy object mapping between the object 208 and the access policy 202 and (ii) a second policy object mapping between the object 210 and the access policy 202. In some cases, the one or more attributes of the object can correspond to the entire object. Alternatively, in one or more embodiments, portions of the objects 208, 210 can have varying attributes. For example, a first portion of the object 208 can be a risk object corresponding to a critical risk level and a second portion of the object 208 can be a risk object corresponding to a non-critical risk level.

As further shown in FIG. 2, the access policy 202 can dictate or include one or more permissions 212. More specifically, the one or more permissions 212 can include actions that the user account 204 and/or group of user accounts 206 can perform on the one or more objects 208, 210 based on the set of rules outlined in the access policy 202. For example, the one or more permissions 212 can include, but are not limited to, reading, editing, approving, deleting, copying, sharing, and/or closing one or more objects 208, 210.

In some cases, the access permission management system 100 can associate one or more permissions 212 with the access policy 202, the one or more attributes of the user account 204 and/or group of user accounts 206, and the one or more attributes of the one or more objects 208, 210. Subsequently, the access permission management system 100 can provide access to the one or more permissions 212 based on the access policy 202, the one or more attributes of the user account 204 and/or group of user accounts 206, and the one or more attributes of the one or more objects 208, 210. For example, the access policy 202 can indicate that the group of user accounts 206 associated with a financial department and with a managerial level can edit performance reports (e.g., objects) for auditors within the financial department, whereas auditors within the financial department can only read their own performance reports. Based on the one or more permissions 212 outlined by the access policy 202, the group of user accounts 206 for managers within the financial department can edit performance reports for several auditors, while the user accounts for auditors can only view their own performance report.

As just described the access policy 202 can dictate which user accounts can access and/or perform permissions on one or more objects within the tenant database. To further illustrate aforementioned discussion, in one or more embodiments, the access policy 202 can indicate that only user accounts corresponding to an executive level can edit objects associated with a critical risk. Based on the user account 204 corresponding to an executive level user and the object 208 corresponding to a critical risk, the access permission management system 100, via the eager evaluation model, can generate a policy subject mapping indicating that the user account 204 can access the access policy 202.

Moreover, the access permission management system 100 can generate a policy object mapping that maps the object 208 to the access policy 202 based on the critical risk of the object 208. Additionally, the access permission management system 100 can generate an association with the one or more permissions 212 and the access policy 202 indicating that the user account 204 can edit the object 208. As discussed in more detail below, the access permission management system 100 can store the policy subject mappings and/or the policy object mappings in a table within the tenant database.

In some cases, the access permission management system 100 can generate an exclusionary access policy. In particular, the exclusionary access policy can dictate that one or more user accounts cannot access a subset of objects from the one or more objects stored in the tenant database. For example, the exclusionary access policy can outline that managers associated with the marketing group cannot access medium risk objects. As discussed above, the access permission management system 100 can generate mapping records indicating that the subset of user accounts cannot gain access to the subset of objects. For example, the access permission management system 100 can generate policy object mappings and policy subject mappings indicating that the subset of user accounts cannot access the subset of objects. In one or more implementations, the access permission management system 100 can utilize the mapping records to deny the subset of user accounts access to the subset of objects based on the exclusionary access policy.

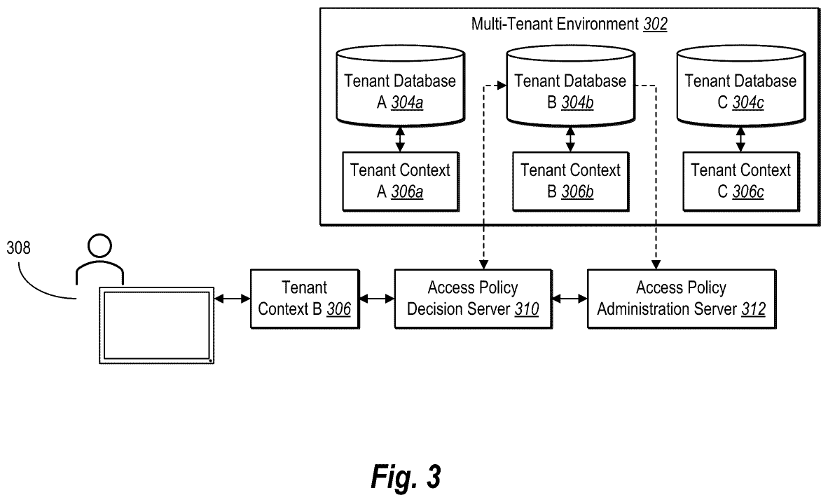

As mentioned above, the access permission management system 100 can utilize an ABAC framework executing an eager evaluation model within a multi-tenant environment. FIG. 3 illustrates an access permission management system 100 linking to a tenant database within a multi-tenant environment in accordance with one or more embodiments. As shown in FIG. 3, a multi-tenant environment 302 can include, based on security regulations and requirements, separate tenant databases for each tenant. For instance, as shown in FIG. 3, the multi-tenant environment 302, can include a tenant database A 304a for tenant A, a tenant database B 304b for tenant B, and a tenant database C 304c for tenant C.

Moreover, as further illustrated in FIG. 3, the access permission management system 100 can generate tenant contexts for each tenant and associate (or link) the tenant context to the tenant database for use in determining which tenants are associated with subsequent requests to access objects. As used herein, the term “tenant context” refers to an identifier, name, or descriptor associated with a tenant and indicating the tenant in a multi-tenant environment. In one or more cases, the tenant context can include metadata associated with a tenant and/or the tenant database. For example, the metadata can include information about the user accounts, objects, departments, security requirements, data encryption settings, network information, device information, or other information, associated with the tenant in connection with a request to access one or more objects. In one or more embodiments, the access permission management system 100 can generate a tenant context based on the tenant. For example, the access permission management system 100 can generate a tenant context comprising a tenant identifier that corresponds to the tenant and assign the tenant context to user accounts associated with the tenant (e.g., for inclusion in or otherwise associating with requests submitted to the access permission management system 100).

In some cases, the access permission management system 100 can generate a tenant context corresponding to a tenant database based on one or more attributes of the one or more user accounts associated with the tenant. For example, the access permission management system 100 can identify attributes, such as, email, identification, login conventions of the user accounts and associate those with a tenant and generate the tenant context based on identified attributes. To further illustrate, the access permission management system 100 can identify a domain (e.g., email server, domain, and/or top-level domain) for user accounts associated with the tenant (or entity) and generate the tenant context based on the domain of the user accounts associated with the tenant. In additional embodiments, the access permission management system 100 obtains a tenant context from another system or device (e.g., from the tenant database itself).

As shown in FIG. 3, the access permission management system 100 can associate the tenant context with the tenant database and store the tenant context in a primary database. For example, the access permission management system 100 can associate a tenant context A 306a with the tenant database A 304a, a tenant context B 306b with the tenant database B 304b, and a tenant context C 306c with the tenant database C 304c.

In one or more embodiments, the access permission management system 100 can distinguish the tenant databases utilizing the tenant contexts and link the ABAC framework to the appropriate tenant database by employing the tenant contexts. For example, as shown in FIG. 3, the access permission management system 100 can identify a user account 308 associated with a tenant that is requesting to access one or more objects within a tenant database. Based on the user account 308 associated with the request and/or based on additional information included in the request, the access permission management system 100 can determine a tenant context that corresponds to the user account 308. For example, as shown in FIG. 3, the access permission management system 100 can identify one or more attributes and/or an identifier associating the user account 308 with the tenant (e.g., based on an inclusion of a particular tenant identifier in a request from the user account 308) and determine that the user account 308 corresponds to the tenant context B 306b. In some embodiments, the access permission management system 100 can store user accounts and their association with the tenant. Thus, based on the user account and their association with the tenant from the stored information, the access permission management system 100 can determine the tenant context. Additionally, the access permission management system 100 can store one or more attributes (e.g., email and/or domain) of the user account 308 and determine the tenant context based on the one or more attributes.

As further shown in FIG. 3, upon determining the tenant context B 306b for the user account 308, the access permission management system 100 can link (or connect) the ABAC framework (e.g., the one or more hardware processors or the access policy administration server, access policy decision server, and/or the access policy enforcement server) to the tenant database associated with the tenant context. In particular, the access permission management system 100 can include the tenant context when calling into the multi-tenant environment 302 (or database framework) to identify which tenant database to access. For example, as FIG. 3 illustrates, the access permission management system 100 can include the tenant context B 306b along with a request (or call) to access the one or more objects within the tenant database B 304b.

As further shown in FIG. 3, the access permission management system 100 can utilize the tenant context B 306b to link an access policy decision server 310 and an access policy administration server 312 (parts of an ABAC architecture) to the tenant database B 304b. Upon connecting the access policy decision server 310 and the access policy administration server 312 with the tenant database B 304b, the access permission management system 100 can determine what access the user account 308 has to the one or more objects within the tenant database B 304b.

Relatedly, when receiving an indication of a creation of the access policy, the access permission management system 100 determine the tenant context associated with the user account (e.g., an administrative user account) and include the tenant context to link the ABAC framework to the proper tenant database while the access permission management system 100 executes the eager evaluation model on the set of rules of the access policy. Indeed, the access permission management system 100 can dynamically link to each tenant database within the multi-tenant environment 302 when evaluating the access policy and/or when receiving a request to access one or more objects within the tenant database.

As just discussed, the access permission management system 100 can link an ABAC framework into separate tenant databases within a multi-tenant environment. FIG. 4 illustrates the access permission management system 100 utilizing an ABAC framework comprising an access policy administration server, an access policy enforcement server, and an access policy decision server to determine access of one or more objects for one or more user accounts in accordance with one or more embodiments.

As mentioned above, the access permission management system 100 can utilize an eager evaluation model to immediately evaluate a set of rules (or conditions) associated with an access policy and/or changes to the access policy. As shown in FIG. 4, the access permission management system 100 can receive an access policy 402 from a client device associated with a user account that performs policy administration 400. For example, the access permission management system 100 can receive (e.g., from an administrative user account) an indication of a creation and/or activation of the access policy 402 granting a group of user accounts access and one or more permissions for one or more objects within a tenant database 418.

As shown in FIG. 4, the access permission management system 100 can receive the access policy 402 via an access policy administration server 404 and trigger eager evaluation of the access policy 402. In one or more embodiments, the term “access policy administration server” refers to a policy information point (PIP) within the ABAC framework. In particular, the access policy administration server 404 can include a microservice that (i) manages one or more access policies and (ii) accesses data (e.g., metadata) about one or more attributes of the objects associated with and/or stored within the tenant database 418. For example, the access policy administration server 404 can collect or gather information from the tenant database 418 about one or more objects within the tenant database 418. In some embodiments, the access policy administration server 404 can gather environmental information about one or more client devices associated with one or more user accounts related to the tenant 422.

As further shown in FIG. 4, once the access policy administration server 404 receives the access policy 402, the access permission management system 100 can send the access policy 402 as an access policy message through a message queue 406 to an object management microservice 408 via an access policy modification component 410 adopted by (or linked to) the object management microservice 408. In some cases, the access policy modification component 410 comprises a library of access policies that the access policy modification component 410 along with an access policy decision server 416 can utilize to evaluate, update, delete, and/or monitor access policies. For example, as discussed in more detail below, the access policy modification component 410 can determine if a change to an object will affect or change the access policy 402. If the change to the object affects the access policy 402, the access policy modification component 410 can update the access policy 402 and inform the access policy decision server 416 about the updated access policy.

In one or more cases, the access permission management system 100 executes the eager evaluation model on the access policy 402 via the access policy modification component 410. In particular, the access policy modification component 410 can execute eager evaluation of the access policy 402 by generating an indirect access control list 412 (or indirect ACL) comprising the policy subject mappings and/or the policy object mappings associated with the access policy 402. For example, as described above, the access permission management system 100 can generate the policy subject mappings and the policy object mappings for the access policy 402 and send the policy subject mappings and the policy object mappings as the indirect access control list 412 to an access policy decision server 416 via an additional message queue 414 (e.g., checkpost events).

As just mentioned, the access policy decision server 416 can receive the indirect access control list 412. As used herein, the term “access policy decision server” refers to a policy decision point that (i) eagerly evaluates access policies and (ii) determines whether to permit or deny access to the one or more objects within the tenant database 418 based on the access policy 402. For example, as described above, the access policy decision server 416 can include the access policy modification component 410. In particular, the access permission management system 100 can embed the access policy modification component 410 into the object management microservice 408 to execute the eager evaluation of the access policy 402 by generating the indirect access control list 412 (or policy object mappings and policy subject mappings) for the access policy 402. Additionally, in one or more embodiments, the access policy decision server 416 can store the indirect access control list 412 (or the policy subject mappings and the policy object mappings) and send the indirect access control list 412 for storage in the tenant database 418.

In one or more embodiments, the access permission management system 100 can monitor and/or detect changes to the access policy 402 via the access policy modification component 410 based on the creation, deletion, and/or updates of access policies and/or changes to one or more objects affecting one or more access policies.

As previously indicated, the access permission management system 100 can detect the creation of an additional access policy. In particular, as just described, the access permission management system 100 can execute the eager evaluation model on the set of rules of the additional access policy via the aforementioned process flow and communication of the access policy administration server 404, the message queue 406, the object management microservice 408, the access policy modification component 410, the indirect access control list 412, the additional message queue 414, the access policy decision server 416, and the tenant database 418. Accordingly, in response to creation of the additional access policy, the access permission management system 100, via the access policy modification component 410, can generate additional policy object mapping(s) that maps the additional access policy to the one or more objects within the tenant database 418 and additional policy subject mapping(s) that maps the additional access policy to the one or more user accounts.

As mentioned above, the access policy administration server 404 can monitor for changes to the one or more attributes of the one or more objects within the tenant database 418 and the one or more user accounts associated with the tenant 422. For instance, the access permission management system 100, via the access policy administration server 404, can detect creation (or addition) of new objects, updates to the one or more objects, and/or deletion of the one or more objects within the tenant database 418. To further illustrate, the access policy administration server 404 can detect a change in a level of risk, type, status, and/or owner of the one or more objects within the tenant database 418. In some cases, the access policy administration server 404 can send, via the message queue 406, the one or more changes (or more simply change(s)) to the one or more attributes of the one or more objects within the tenant database 418 to the access policy modification component 410.

Relatedly, the access permission management system 100 can detect or receive one or more changes to one or more user accounts or a group of user accounts. For example, the status of a user account can change from an employee role to a managerial role. Accordingly, the access policy modification component 410 can determine if a change to the role (e.g., attribute) of the user account affects the access policy 402.

In one or more cases, upon receiving the change(s) to the one or more objects within the tenant database 418, the access policy modification component 410 can implement eager evaluation of the change(s) of each object to determine if the change(s) affect any of the existing access policies. For instance, the access permission management system 100, via the access policy modification component 410, can fetch all the access policies related to the object and determine if the changes place the object into a new or different set of access policies or removes the object from a set of access policies. Likewise, the access permission management system 100 can determine if the changes to a user account (or group of user accounts) removes or adds the user account or group of user accounts to a different access policy.

In some cases, if the change(s) to the one or more objects affects (e.g., includes and/or removes the object from) the access policy 402, the access policy modification component 410 can update the policy object mappings based on the change(s) to the access policy 402. Accordingly, in one or more embodiments, the access policy modification component 410 can send the updated policy object mappings as updated indirect ACLs to the access policy decision server 416, via the additional message queue 414, for storage within the access policy decision server 416 and the tenant database 418. For example, based on the level of risk of an object increasing from a low risk to a high risk adding the object to the access policy 402, the access policy modification component 410 can update the policy object mapping between the object and the access policy 402 and the access policy decision server 416 can receive the updated indirect ACL. Additionally, the access permission management system 100, via the access policy modification component 410, can update policy subject mappings based on the changes of the user account and/or group of user accounts to the access policy. As discussed above, the access policy modification component 410 can send the updated policy subject mappings as updated indirect ACLs to the access policy decision server 416. Thus, the access permission management system 100 can change the access of the user account based on changes to one or more attributes of the user account and/or to the object based on changes to one or more attributes of the object.

Relatedly, in one or more embodiments, the access permission management system 100 can monitor the deletion or addition of an object, detect a change to the access policy 402 (or access policy change) based on the addition or deletion of the object and update the policy object mapping based on the access policy change. Indeed, the access permission management system 100 can actively monitor and update mapping records for the one or more objects within the tenant database 418 based on one or more changes to the access policy 402.

Likewise, in some implementations, the access permission management system 100 can monitor the deletion or addition of a user account and detect a change to the access policy 402. For example, the access permission management system 100 can detect a role change of a user account that places the user account in a role that has access to objects with a high level of risk. For example, the access permission management system 100 can detect the role of a user account changing from manager to department head. Based on the change in roles, the access permission management system 100 via the access policy modification component 410 can determine that the user account should have access to an object with a level of high risk and be added to the access policy 402. The access permission management system 100 via the access policy modification component 410 can generate an indirect ACL (or policy subject mapping) associating the user account with the access policy 402.

As just described, the access permission management system 100 can execute the eager evaluation model to instantly evaluate access policies. As indicated above, the access permission management system 100 can provide and/or deny access of one or more objects within the tenant database 418 to the one or more user accounts associated with the tenant 422.

As shown in FIG. 4, the access permission management system 100 can receive a request for access 420 (or a request query) from the user account associated with a tenant 422 to access one or more objects within the tenant database 418. In particular, the request for access 420 can request access to a single object within the tenant database 418 or a list (e.g., multiple) objects within the tenant database 418. In certain implementations, the access permission management system 100 can utilize different components based on the type of request for access 420 to efficiently determine if the user account can access the single object or the list of objects.

In one or more embodiments, the access permission management system 100 can identify the type of the request for access 420. For example, based on the object management microservice 408 receiving the request for access 420, the access permission management system 100 can determine if the request for access 420 is requesting to access a single object or multiple objects. As indicated in FIG. 4, the access policy modification component 410 can facilitate how the object management microservice 408 interacts with the access policy decision server 416 and an access policy enforcement server 424 while validating the request for access 420. For example, based on the request for access requesting a single object, the access policy modification component 410 can pass the request for access 420 to the access policy enforcement server 424.

As used herein, the term “access policy enforcement server” refers to a policy enforcement point that enforces access to an object within the tenant database 418. In some embodiments, the access policy enforcement server 424 can include a set of libraries and adoption guides that perform access control checks. For example, in some cases, the access policy enforcement server 424 can include hooks/features for validating conditions a request for access (or query) must adopt to call into an application programming interfaces(API). Moreover, in some embodiments, the access policy enforcement server 424 can utilize a library including a Java Archive (JAR) file to perform access control checks in connection with a request involving a subject (e.g., a user account) and an object. In some cases, the access policy enforcement server 424 enforces the determination of the access policy decision server 416 whether to grant or deny access to an object (e.g., single object) within the tenant database 418.

As shown in FIG. 4, once the access policy enforcement server 424 receives the request for access 420 for the single object, the access policy enforcement server 424 can communicate with the access policy decision server 416 to determine if the user account associated with the request for access 420 can access the single object within the tenant database 418. For example, the access policy enforcement server 424 can collect and send the one or more attributes of the user account making the request for access 420 and the identity of the requested object to the access policy decision server 416. Moreover, the access policy decision server 416 can evaluate the one or more attributes of the user account making the request for access 420 and the one or more attributes of the object within the tenant database 418 by comparing the one or more attributes of the user account and the one or more attributes of the object with the access policy 402. Based on the one or more attributes of the user account and the one or more attributes of the object within the tenant database 418 meeting the set of rules (or conditions) outlined by the access policy 402, the access policy decision server 416 can determine that the user account can access the object. In one or more cases, the access policy decision server 416 can communicate the decision to provide access to the object to the access policy enforcement server 424. Subsequently, the access policy enforcement server 424 can grant access to the object and the access permission management system 100 can provide the object for display on a graphical user interface of a client device associated with the user account (or otherwise provide access to the object to the client device).

As just discussed, the access permission management system 100 can utilize a specific process flow for the request for access 420 of the single object. In one or more embodiments, the request for access 420 can request access to a list (e.g., multiple) of objects within the tenant database 418. As shown in FIG. 4, in such cases, the access permission management system 100 can call into a standard query language (SQL) function 426 to access the list of objects within the tenant database 418. In one or more cases, the SQL function 426 can include access control checks corresponding to the access policies associated with the user account. For example, the access control check can verify that the user account meets the set of rules (or conditions) outlined by the corresponding access policy. As shown in FIG. 4, the access permission management system 100 can run the SQL function 426 (or access control checks) on the objects within the tenant database 418 and return the list (e.g., multiple) of objects the user account can access. For example, the access permission management system 100 can provide access to the list of objects for the user account based on the access control check. In some cases, the access permission management system 100 can return and provide for display on the graphical user interface of the client device associated with the user account, the list of objects.

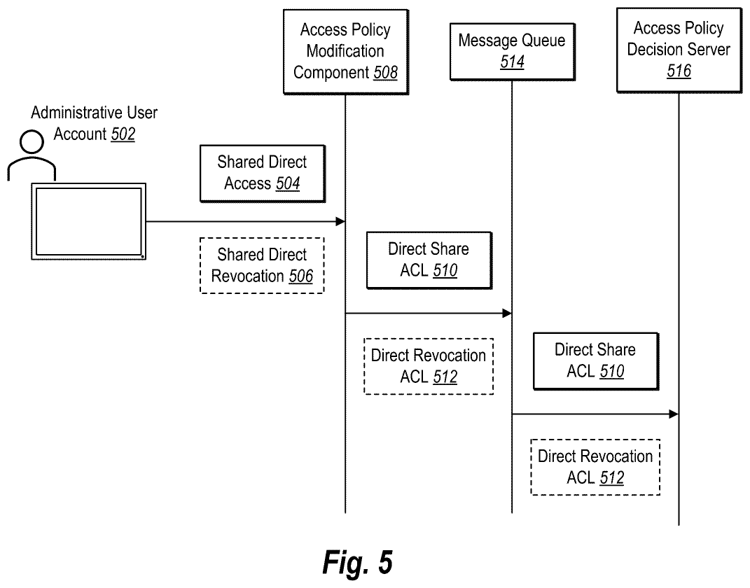

As just discussed, the access permission management system 100 can utilize access policies to determine whether to grant or deny one or more user accounts access of one or more objects stored within a tenant database. FIG. 5 illustrates the access permission management system 100 directly sharing or revoking access to an object within the tenant database. In particular, FIG. 5 illustrates an example of an access permission management system 100 receiving shared direct access and/or shared direct revocation of access to an object from a user account in accordance with one or more embodiments.

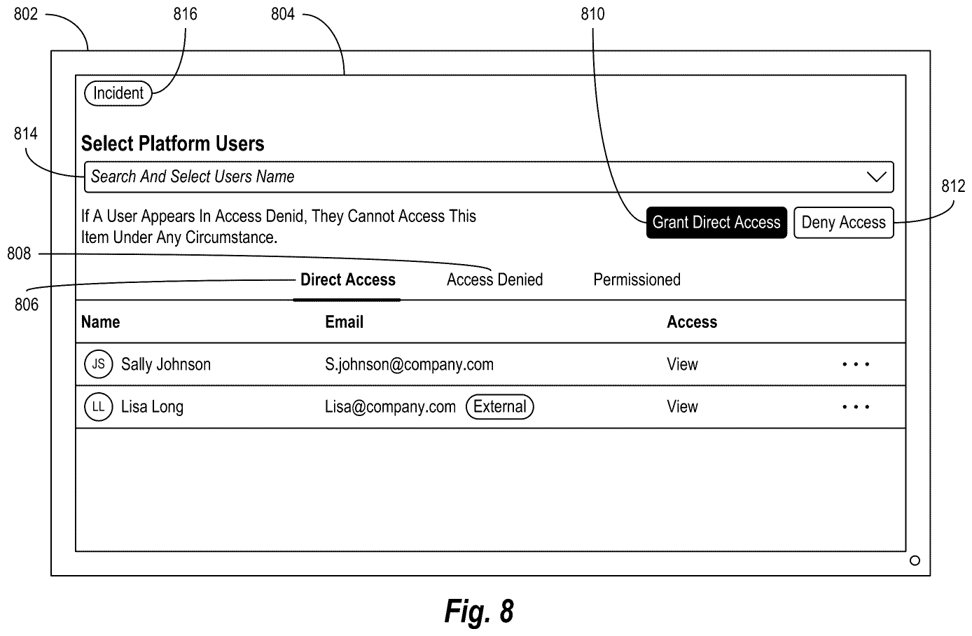

As just mentioned, the access permission management system 100 can provide direct access to an object from the one or more objects within a tenant database without generating or utilizing an access policy dictating that the user account and/or group of user accounts can access the object. In some implementations, the access permission management system 100 can receive an indication of the shared direct access 504 by receiving (or detecting) a selection of or user interaction with a direct access selectable element for an object indicating that user account or group of user accounts should have access to the object. For example, the access permission management system 100 can receive a selection of the object from a client device associated with the administrative user account 502 and based on the selection of the object, provide the object for display within a graphical user interface on the client device associated with the administrative user account 502. For example, as discussed below in FIG. 8, the access permission management system 100 can provide for display within the graphical user interface a direct access selectable element (e.g., button, input field, selection box) along with the object.

In one or more embodiments, based on receiving the indication of the shared direct access 504 from the administrative user account 502, the access permission management system 100, via the access policy modification component 508, can receive the shared direct access 504 of the object indicating that the user account and/or group of user accounts should have access to the object even though they are not granted access to the object through an access policy.

As indicated in FIG. 5, once the access policy modification component 508 receives the shared direct access 504, the object management microservice can generate a direct-share ACL 510 by associating the object with the user account and/or group of user accounts. Indeed, the direct-share ACL 510 can reflect the association between the object and user account and/or group of user accounts.

As FIG. 5 further shows, the access permission management system 100 can receive the direct-share ACL 510 at an access policy decision server 516 linked to the access policy modification component 508 via a message queue 514. In one or more embodiments, once the access policy decision server 516 receives the direct-share ACL 510, the access policy decision server 516 can store the direct-share ACL 510 and send the direct-share ACL to the tenant database for storage. Thus, the access permission management system 100 can facilitate the direct sharing of an object with one or more user accounts without generating an access policy by utilizing the direct-share ACL 510 to provide access of the object to the user account and/or group of user accounts based on the direct-share ACL 510. Thus, if the access policy does not provide access to an API endpoint (or object) for the user account of an entry level employee, the user account of the entry level employee can gain access to the API endpoint based on the direct-share ACL 510 providing such access.

Alternatively, the access permission management system 100 can directly revoke access to an object from one or more user accounts. As described above, the access permission management system 100 can receive from a client device associated with the administrative user account 502 an indication of a shared direct revocation 506 of access to an object (or subset of objects) for a user account associated with the tenant. As described above, the access permission management system 100 can receive the shared direct revocation 506 via the access policy modification component 508 and utilize the linked object management microservice to generate a direct revocation ACL 512 by associating a denial (or revocation) of access between the user account and the object.

As shown in FIG. 5, the access permission management system 100 can send the direct revocation ACL 512 via the message queue 514 to the access policy decision server 516, where the access policy decision server 516 can store the direct revocation ACL 512 and send the direct revocation ACL 512 to the tenant database for storage. In one or more embodiments, the direct revocation ACL 512 takes priority to or overrides the set of rules (or conditions) outlined in the access policy. For example, if the access policy indicates that user accounts associated with a managerial level can access an incident report (or object) and the direct revocation ACL 512 states that the user account associated with the managerial level of Jim Johnson cannot access the incident report, the user account of Jim Johnson cannot access the user account.

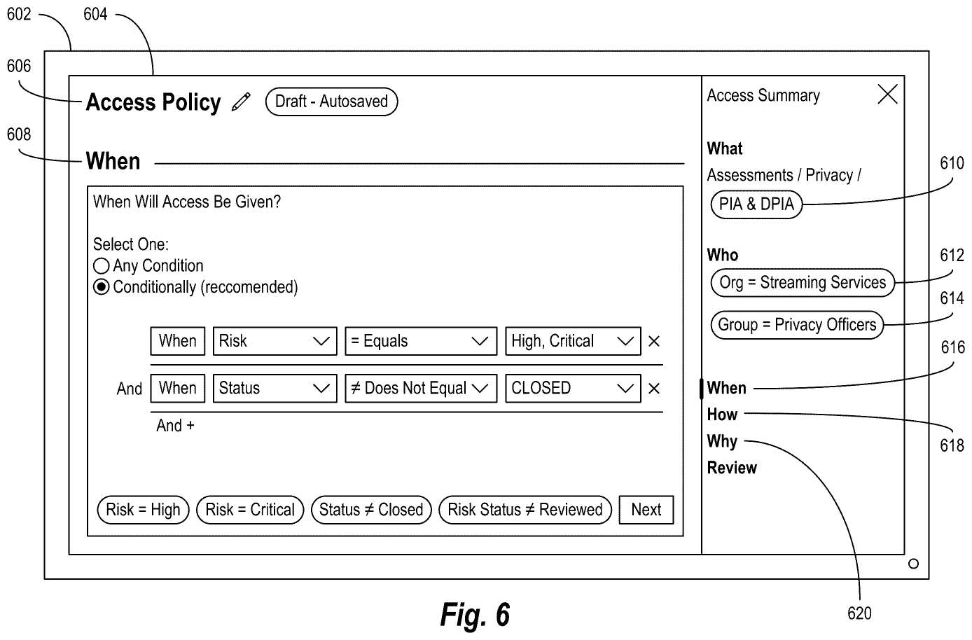

As described above, the access permission management system 100 can provide or deny access to one or more objects within a tenant database based on an access policy, shared direct access, or shared direct revocation of access. FIG. 6 illustrates an example of a graphical user interface for generating an access policy in accordance with one or more embodiments.

As shown in FIG. 6, the access permission management system 100 can provide for display on a client device 602 an access policy graphical user interface 604 where a user account with the appropriate clearance can generate access policies. For example, as shown in FIG. 6., the access permission management system 100 can receive a set of rules (or conditions) for an access policy 606 regarding object(s) 610 (e.g., what), a tenant 612, user account(s) 614 (e.g., who), one or more attributes 616 of the object(s) outlined by the access policy (e.g., when), permissions 618 (how), and a reason 620 for generating the access policy (e.g., why).

In some cases, the access permission management system 100 can provide for display various windows of the access policy graphical user interface 604 corresponding to the object(s) 610, the tenant 612, the user account(s) 614, the one or more attributes 616 of the object(s), the permissions 618, and/or the reason 620 for generating the access policy 606. For example, the access permission management system 100 can provide for display an access policy attributes window 608 (or tab) within the access policy graphical user interface 604 with one or more input fields where the access permission management system 100 can receive input from the client device 602 outlining the one or more attributes 616 of the object(s) 610 that correspond to the access policy 606. For example, as indicated in FIG. 6, the access permission management system 100 received user input (or user interactions) via the client device 602 indicating that the access policy 606 controls access to privacy impact assessments (PIAs) and protection impact assessments (DPIAs) by setting the risk of the PIAs and DPIAs to high and critical and indicating that privacy officers can access PIAs and DPIAs that are not closed.

Accordingly, FIG. 6 indicates that the access permission management system 100 can provide for display additional windows within the access policy graphical user interface 604 comprising one or more input fields outlining the user accounts, groups of user accounts, and tenants (e.g., entities) relating to the access policy 606. For example, as shown in FIG. 6, the access permission management system 100 received user input indicating that privacy officers (e.g., user account(s) 614) of the streaming service (e.g., the tenant 612) can access the PIAs and DPIAs mentioned above.

As further shown in FIG. 6, the access policy graphical user interface 604 can include an additional window (or tab) where the access permission management system 100 can receive user input via the client device 602 dictating what permissions the user account(s) 614 of the tenant 612 can perform on the object(s) 610. For example, the access permission management system 100 can receive user input outlining that permissions 618 of the access policy 606 allow the privacy officers to edit and view the PIAs and DPIAs.

In some cases, the access policy graphical user interface 604 can include an additional window (or tab) with an input field where the access permission management system 100 can receive user input dictating the reason 620, basis, rationale, or goals of the access policy 606. Finally, the access permission management system 100 can provide a review of the access policy outlining the one or more attributes 616 of the object(s) 610, the tenant 612, the user account(s) 614 affected by the access policy 606 along with the permissions 618 allowed by the access policy 606, and the reason 620 for creating and/or enforcing the access policy 606. As described above, once the access permission management system 100 receives the access policy 606, the access permission management system 100 can execute the eager evaluation model to assess and enforce the access policy 606.

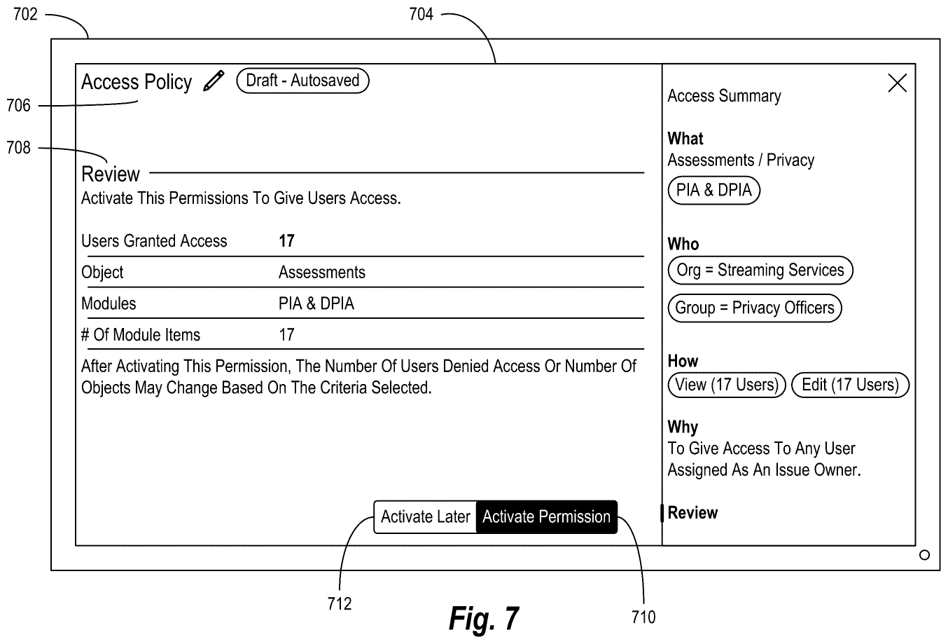

As just mentioned, the access permission management system 100 can include one or more windows (or tabs) within an access policy graphical user interface where the access permission management system 100 can receive the set of rules (or conditions) associated with an access policy. FIG. 7 illustrates another example of a graphical user interface for reviewing and activating an access policy in accordance with one or more embodiments.

As shown in FIG. 7, the access permission management system 100 can provide for display an access policy graphical user interface 704 on a client device 702 with an access policy review window 708. As shown in FIG. 7, the access policy review window 708 can include an overview of which user accounts can access certain objects. For example, the access policy review window 708 can indicate that 17 privacy officers (e.g., group of user accounts) have access to 17 PIAs and DPIAs. Moreover, the access policy review window 708 indicates that the 17 privacy officers can view and edit the 17 PIAs and DPIAs.

As further shown in FIG. 7, the access permission management system 100 can provide within the access policy review window 708 one or more selectable elements for activating the access policy 706. For example, the access policy review window 708 can include a selectable activation element 710 for activating the access policy 706. For example, the access permission management system 100 can receive and/or detect a selection of the selectable activation element 710 and based on the detected selection execute the eager evaluation model on the set of rules of the access policy 706.

As further shown in FIG. 7, the access policy review window 708 can include a selectable delay activation element 712. In one or more embodiments, the selectable delay activation element 712 can activate (or create) the access policy 706 after a specified amount of time. For example, based on receiving and/or detecting a selection of the selectable delay activation element 712, the access permission management system 100 can activate the access policy 706 the following business day. In some embodiments, the access permission management system 100 can receive user input indicating when the access policy 706 should go live (e.g., start of next quarter).

As discussed above, the access permission management system 100 can directly share access of an object with a user account or directly revoke access of an object from a user account. FIG. 8 illustrates another example of a graphical user interface for providing direct access to one or more objects or directly revoking access to one or more objects for one or more user accounts in accordance with one or more embodiments.

As shown in FIG. 8, the access permission management system 100 can provide for display on a client device 802 a direct access graphical user interface 804 regarding shared direct access and/or shared revocation of access for an incident object 816. As shown in FIG. 8, the access permission management system 100 can provide for display a list of user accounts with direct access to the incident object 816 and with direct revoked access to the incident object 816.

In one or more embodiments, the direct access graphical user interface 804 can include one or more input fields and/or selectable elements to add or remove the user account from the direct access list and/or the direct revoked access list. For example, in one or more cases, the access permission management system 100 can receive, via a user account input field 814, a name, email, username, or identification number for a user associated with a user account for a tenant. For example, the access permission management system 100 can receive, via the user account input field 814, the email Sjohnson@company.com and retrieve a user account for Sally Johnson.

Subsequently, in one or more cases, upon retrieving the user account for Sally Johnson, the access permission management system 100 can receive from the client device 802 a selection of a selectable direct access element 810 indicating that Sally Johnson should have access to the incident object 816. Upon receiving the selection of the selectable direct access element 810 (or indication of the shared direct access 806), the access permission management system 100 can receive the shared direct access 806 reflecting that Sally Johnson has access to the incident object 816. Moreover, the access permission management system 100 can generate a link (or association) between the user account of Sally Johnson and the incident object 816 and provide the user account of Sally Johnson with access to the incident object 816 without generating an access policy or modifying any existing access policies.

Likewise, the access permission management system 100 can revoke (or deny) access of the user account from the object. For example, as described above, in one or more cases, the access permission management system 100 can retrieve the user account for Sally Johnson and receive a selection of the selectable direct revocation element 812. Based on receiving the selectable direct revocation element 812, the access permission management system 100 can receive a shared direct revocation of access 808 to the incident object 816 reflecting that the user account of Sally Johnson does not have access to the incident object 816 under any circumstances and deny the user account of Sally Johnson access to the incident object 816 without generating an exclusionary access policy or modifying any existing exclusionary access policies. Additionally, in one or more embodiments, the access permission management system 100 can directly grant access or directly revoke access to an object for a subset of one or more user accounts or a group of user accounts.

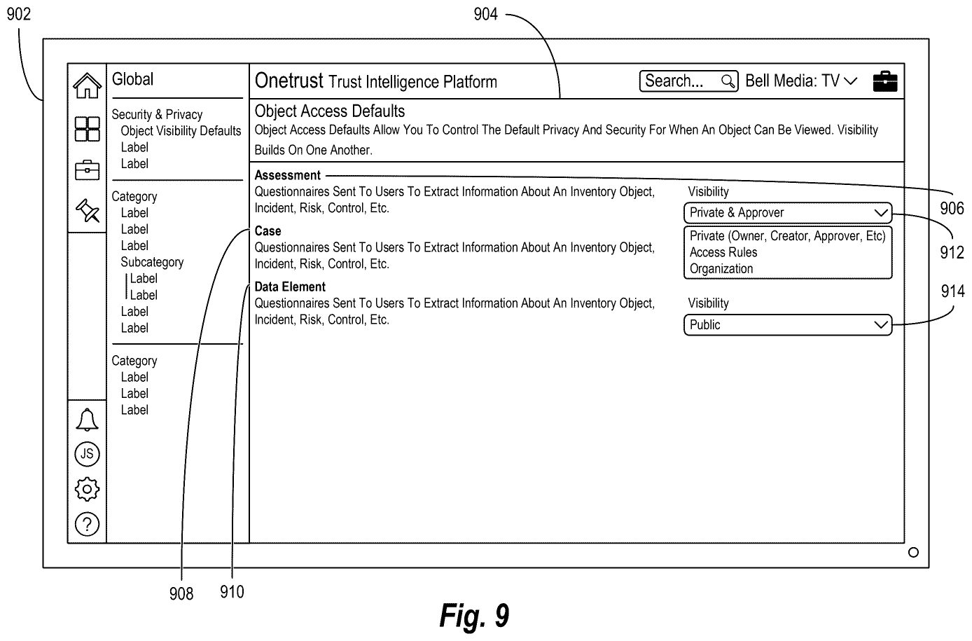

Turning now to FIG. 9, the access permission management system 100 can provide for display on a client device 902 a default access policy graphical user interface 904 where the access permission management system 100 can easily receive user input from a user account (e.g., administrative user account) for modifying default access policy settings. Indeed, FIG. 9 illustrates another example of a graphical user interface for receiving user input modifying default access policies in accordance with one or more embodiments.

As shown in FIG. 9, the access permission management system 100 can set default access policy settings for one or more objects and/or one or more user accounts. For example, the access permission management system 100 can generate a default access policy where the access permission management system 100 can assign a default level or risk and/or default attributes to an assessment object 906, a case object 908, and a data element object 910. For example, the access permission management system 100 can generate a default access policy where any object with a default level of risk of 3 is accessible to any user account associated with a managerial role or department head. In particular, the access permission management system 100 can set the assessment object 906, the case object 908, and the data element object 910 at a default level of risk of three and based on the default access policy, providing access to the assessment object 906, case object 908, and the data element object 910 to any user account associated with a managerial role or department head. In some embodiments, the access permission management system 100 can include one or more default levels of risk and associated those default levels of risk with certain user accounts or groups of user accounts.

As shown in FIG. 9, the access permission management system 100 can provide for display the default access policy graphical user interface 904 with one or more selectable elements 912, 914 and/or input fields for receiving modifications to the default access policies associated with the assessment object 906, the case object 908, and the data element object 910. For example, as just mentioned, the access permission management system 100 can associate, based on the default access policy, a default level of risk (e.g., private, access rules, organization, trust domain, all domain, internal users) with a default type of user account (e.g., CEO, head of IT, managerial roles, internal users, employees). As shown in FIG. 9, the access permission management system 100 can update or modify the default access policy associated with the assessment object 906, the case object 908, or the data element object 910 based on receiving user input with the one or more selectable elements 912, 914 changing the default level of security for the assessment object 906, the case object 908, or the data element object 910. For example, as shown in FIG. 9, the access permission management system 100 can receive user input updating the default access policy associated with the assessment object 906 by receiving a selection of the selectable element 912 changing the default level of security of the assessment object 906 from organizations to private approver. Based on the change, the access permission management system 100 will apply the default access policy that only user accounts of C-suite users can access the assessment object 906.

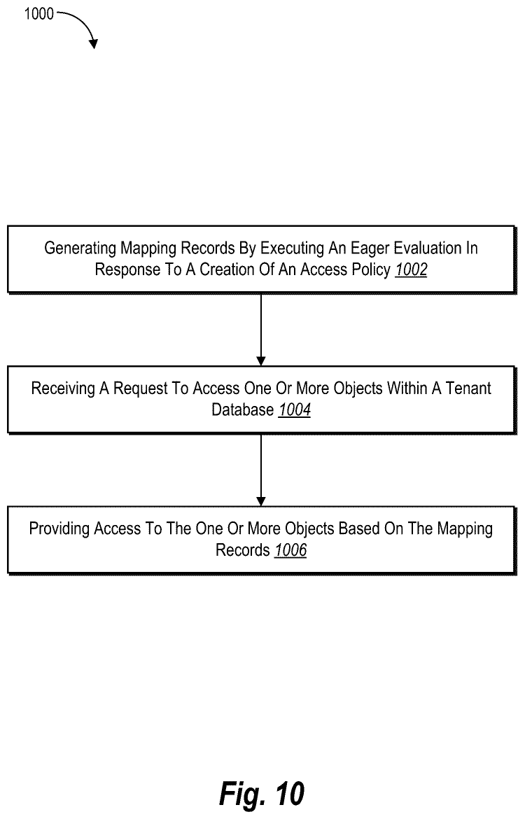

Turning now to FIG. 10, this figure shows a flowchart of providing access to one or more objects based on mapping records, in accordance with one or more embodiments. While FIG. 10 illustrates acts according to one embodiment, alternative embodiments may omit, add to, reorder, and/or modify any of the acts shown in FIG. 10. The acts of FIG. 10 can be performed as part of a method. Alternatively, a non-transitory computer readable medium can comprise instructions, that when executed by one or more processors, cause a computing device to perform the acts of FIG. 10. In still further embodiments, a system can perform the acts of FIG. 10.

As shown, the process 1000 includes an act 1002 of generating mapping records by executing an eager evaluation model in response to a creation of an access policy. More specifically, the act 1002 includes generating, by one or more hardware processors and for storing at a tenant database associated with a tenant in a multi-tenant environment, mapping records for one or more user accounts and one or more objects by executing an eager evaluation model on a set of rules in response to a creation of an access policy to: generate one or more policy subject mappings that maps the access policy to the one or more user accounts according to one or more attributes of the one or more user accounts; and generate one or more policy object mappings that maps the access policy to the one or more objects according to one or more attributes of the one or more objects.

The process 1000 also includes an act 1004 of receiving a request to access one or more objects within a tenant database. In one or more implementations, act 1004 includes receiving, by the one or more hardware processors, a request for access to the one or more objects within the tenant database from a user account of the one or more user accounts in connection with the access policy and is implemented using one or more examples described above with respect to FIGS. 4 and 5.

Additionally, the process 1000 includes an act 1006 of providing access to the one or more objects based on the mapping records. In particular, the act 1006 can include providing, by the one or more hardware processors accessing the mapping records at the tenant database, access to the one or more objects for the user account based on the one or more policy subject mappings, the one or more policy object mappings, and one or more attributes of the user account. In one or more aspects, act 1006 is implemented using one or more examples described above with respect to FIGS. 2, 4, and 5.

In one or more implementations, the process 1000 includes generating, via an access policy administration server linked to a tenant database associated with a tenant in a multi-tenant environment, mapping records for one or more user accounts and one or more objects by executing an eager evaluation model on a set of rules in response to a creation of an access policy to link the one or more user accounts to the one or more objects to the access policy via mappings to the access policy. In some cases, the process 1000 also includes receiving, via an access policy enforcement server, a request for access to the one or more objects within the tenant database from a user account of the one or more user accounts in connection with the access policy. Additionally, the process 1000 can include determining, via an access policy decision server linked to the tenant database and communicating with the access policy administration server, access for the user account based on the mappings to the access policy and one or more attributes of the user account. In one or more implementations, the process 1000 includes providing, via the access policy enforcement server communicating with the access policy decision server, access to the one or more objects within the tenant database for the user account based on the access for the user account.

In one or more implementations, the process 1000 includes detecting a creation of an access policy comprising a set of rules. In some cases, the process 1000 also includes generating, by executing an eager evaluation model on the set of rules in response to the creation of an access policy: a policy subject mapping that maps the access policy to a more user account according to one or more attributes of the user account; and a policy object mapping that maps the access policy to an object according to one or more attributes of the object. Additionally, the process 1000 can include receiving a request for access to the object within a tenant database associated with a tenant from a user account of one or more user accounts in connection with the access policy. In one or more implementations, the process 1000 includes providing access to the object for the user account based on the policy subject mapping, the policy object mapping, and the one or more attributes of the user account.

In one or more cases, the process 1000 includes detecting, by the one or more hardware processors, a change to the one or more objects or the one or more user accounts. In some cases, the process 1000 further includes detecting, utilizing the eager evaluation model, an access policy change to the access policy based on the change to at least the one or more objects within the tenant database or the one or more user accounts associated with the tenant. The process 1000 also includes updating, by executing the eager evaluation model, the one or more policy subject mappings or the one or more policy object mappings based on the access policy change.

In one or more cases, the process 1000 can include associating one or more permissions with the access policy, the one or more attributes of the user account, and the one or more attributes of an object of the one or more objects. Moreover, in one or more implementations the process 1000 includes providing access to the one or more permissions based on the access policy, the one or more attributes of the user account, and the one or more attributes of the object.

The process 1000 can include determining, by the one or more hardware processors, an exclusionary access policy corresponding to a subset of user accounts of the one or more user accounts and a subset of objects from the one or more objects. The process 1000 can also include denying, by the one or more hardware processors accessing the mapping records within the tenant database, the subset of user accounts access to the subset of objects based on the exclusionary access policy.

The process 1000 can include generating a tenant context corresponding to the tenant database based on one or more attributes of the one or more user accounts associated with the tenant. The process 1000 can also include determining the tenant context based on the user account associated with the request for access to the one or more objects within the tenant database. In some cases, the process 1000 can include connecting the one or more hardware processors to the tenant database based on the tenant context.

The process 1000 can further include detecting, by the one or more hardware processors, a creation of an additional access policy. Additionally, the process 1000 can include in response to the creation of the additional access policy, generating: one or more additional policy subject mappings that maps the additional access policy to the one or more user accounts; and one or more additional policy object mappings that maps the additional access policy to the one or more objects.

The process 1000 includes receiving, from an administrative user account associated with the tenant, shared direct access of an object from the one or more objects with a user account from the one or more user accounts.

The process 1000 can include based on the creation of the access policy, receiving, via the access policy administration server linked to an object management microservice an access policy message corresponding to the access policy. Furthermore, the process 1000 can also include generating, via the object management microservice linked to an access policy modification component of the access policy decision server, an indirect access control list (ACL) based on evaluating the access policy. In one or more embodiments, the process 1000 can include receiving, via the access policy modification component, the indirect ACL to store in the access policy decision server and the tenant database for storage.

In one or more embodiments, the process 1000 can include detecting, via an access policy modification component of the access policy decision server, one or more changes to the access policy based on one or more changes to the one or more objects. The process 1000 can also include generating an updated indirect access control list (ACL), based on the one or more changes to the access policy. The process 1000 can further include receiving, via the access policy modification component communicating with the access policy decision server, the updated indirect access control list.

In one or more cases, the process 1000 includes receiving, from a client device associated with the user account, a request query to access a plurality of objects associated with the user account. The process 1000 can further include generate a structured query language (SQL) function comprising an access control check corresponding to the access policy. Additionally, the process 1000 can include provide access to the plurality of objects for the user account based on the access control check.

The process 1000 can include receiving, from a client device associated with the user account, a request query to access an object from the one or more objects. The process 1000 can also include based on the request query, sending a request to the access policy decision server via the access policy enforcement server to determine access of the object from the user account.

In certain embodiments, the process 1000 further includes receiving, from a client device associated with an administrative user account, an indication of shared direct access to an object from the one or more objects for a user account. Moreover, the process 1000 can include generating a direct share ACL for the object based on the shared direct access. In one or more cases, the process 1000 includes providing access of the object to the user account based on the direct share ACL

The process 1000 can include generating a tenant context corresponding to the tenant database based on one or more attributes of the one or more user accounts associated with the tenant. Additionally, in one or more cases, the process 1000 can include determining the tenant context based on the user account associated with the request for access to the one or more objects within the tenant database. Moreover, in some embodiments, the process 1000 includes connecting the access policy administration server, the access policy enforcement server, and the access policy decision server to the tenant database based on the tenant context

In some embodiments, the process 1000 can include detecting a deletion or an addition of an object of one or more objects or a user account of the one or more user accounts in connection with the tenant. The process 1000 can further include detecting an access policy change to the access policy based on the deletion or the addition of the object within the tenant database or the user account in connection with the tenant. The process 1000 can also include updating the policy subject mapping or the policy object mapping based on the access policy change.

The process 1000 can include associating one or more permissions with the access policy, the one or more attributes of the user account, and the one or more attributes of the object, wherein the one or more permissions comprise reading, editing, or approving the object. In some cases, the process 1000 further includes providing access to the one or more permissions based on the access policy, the one or more attributes of the user account, and the one or more attributes of the object.

The process 1000 can also include identifying one or more attributes of the user account associated with the tenant. The process 1000 can further include generating, by executing the eager evaluation model, the policy subject mapping based on the one or more attributes of the user account.

Additionally, the process 1000 can include identifying one or more attributes of the object within the tenant database. The process 1000 can also include generating, by executing the eager evaluation model, the policy object mapping based on the one or more attributes of the object.

The process 1000 can include receiving, from a client device associated with an administrative user account associated with the tenant, an indication of a shared direct revocation of access of an object from one or more objects within the tenant database for the user account from the one or more user accounts associated with the tenant. The process 1000 can further include revoking access to the object for the user account based on the shared direct revocation of access.

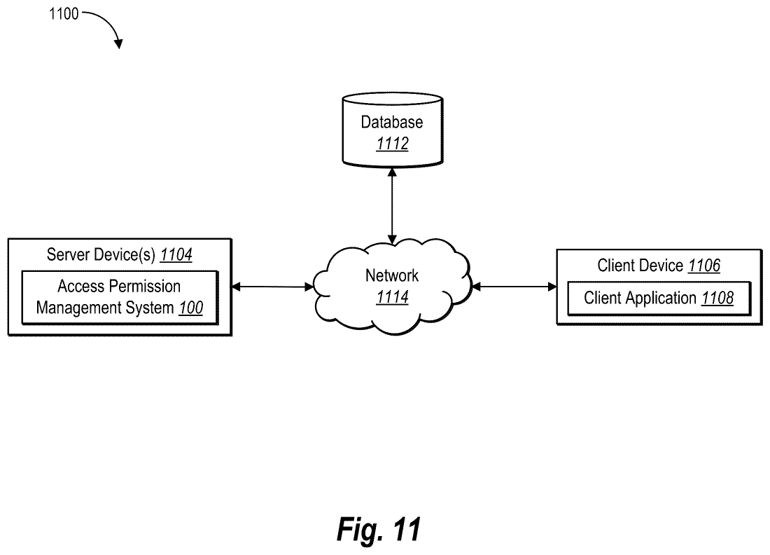

Turning now to FIG. 11, which includes an aspect of a system environment 1100 in which an access permission management system 100 is implemented. In particular, the system environment 1100 includes a server device 1104, a client device 1106, and a database 1112 in communication via a network 1114. FIG. 11 also shows that the client device 1106 includes client application 1108.

As shown in FIG. 11, in one or more aspects, the server device 1104 can include or host the access permission management system 100. Specifically, the access permission management system 100 includes, or is part of, an ABAC framework that utilizes an eager evaluation model to control access to one or more objects within a tenant database hosted within the multi-tenant environment of the database 1112. For example, the access permission management system 100 provides tools to the client device 1106 for generating access policies and/or accessing one or more objects within the tenant database. In one or more aspects, the access permission management system 100 provides tools to the client device 1106 via the client application 1108 for creating, viewing, and managing access policies.

According to one or more aspects, the access permission management system 100 links to the tenant database stored within the database 1112 by utilizing a tenant context to select the tenant database that corresponds to the user account requesting access to one or more objects within the tenant database or the administrative user account performing policy administration. In one or more cases, the access permission management system 100 can receive or pull information (e.g., metadata, security requirements such as encryption requirements or privacy, legal, or ethical requirements) about the corresponding tenant and the objects within the tenant database. In some aspects, the access permission management system 100 may be configured to communicate with the tenant database stored in the database 1112 via one or more hardware processors.

Furthermore, the access permission management system 100 can communicate with the client device 1106 to obtain information associated with an access policy, to provide for display the set of rules associated with the access policy, or provide for display an object to a user account with granted access to the object. For instance, the access permission management system 100 can obtain, via user input received from the client device 1106, a set of rules defining how one or more attributes associated with user accounts and one or more attributes associated with objects affects access to the one or more objects.

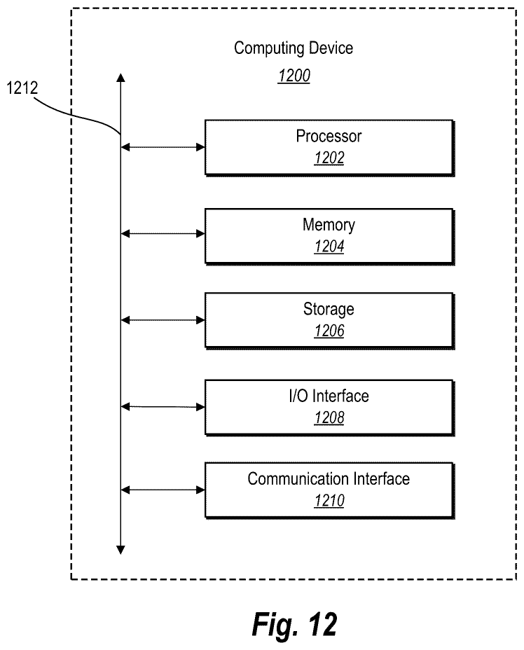

In one or more aspects, the server device 1104 includes a variety of computing devices, including those described below with reference to FIG. 12. For example, the server device 1104 includes one or more servers for storing and processing data associated with one or more data processes. In some aspects, the server device 1104 can also include a plurality of computing devices in communication with each other, such as in a distributed storage environment. In some aspects, the server device 1104 includes a content server. The server device 1104 also optionally includes an application server, a communication server, a web-hosting server, a social networking server, a digital content campaign server, or a digital communication management server.

In one or more aspects, the client device 1106 includes, but is not limited to, a desktop, a mobile device (e.g., smartphone or tablet), or a laptop including those explained below with reference to FIG. 12. Furthermore, although not shown in FIG. 11, the client device 1106 can be operated by users (e.g., a user included in, or associated with, the system environment 1100) to perform a variety of functions. In particular, the client device 1106 performs functions such as, but not limited to, accessing, viewing, and interacting with one or more objects, creating access policies, directly sharing or revoking access of one or more user accounts to one or more objects via the network 1114. Although FIG. 11 illustrates the system environment 1100 with a single client device, in some aspects, the system environment 1100 includes a plurality of client devices.

Additionally, as shown in FIG. 11, the system environment 1100 includes the network 1114. The network 1114 enables communication between components of the system environment 1100. In one or more aspects, the network 1114 may include the Internet or World Wide Web. Additionally, the network 1114 can include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the client device 1106, the database 1112,, and the access permission management system 100 communicate via the network 1114 using one or more communication platforms and technologies suitable for transporting data and/or communication signals, including any known communication technologies, devices, media, and protocols supportive of data communications, examples of which are described with reference to FIG. 12.

Although FIG. 11 illustrates the server device 1104, the client device 1106, and the database 1112 communicating via the network 1114, in alternative aspects, the various components of the system environment 1100 communicate and/or interact via other methods (e.g., the server device 1104, the client device 1106, the database 1112 can communicate directly).

In some aspects, the access permission management system 100 can be executed on a server system that provides a multi-tenant environment. The multi-tenant environment can include a tenant (e.g., one or more user accounts sharing common privileges with respect to an application instance) accessible by a particular set of client devices, as well as other tenants inaccessible to that set of client devices (e.g., access controlled to permit only access from other sets of client devices). For instance, in (or otherwise in connection with) the tenant accessible by a particular client system of one or more client devices, certain objects (e.g., digital datasets) used by the access permission management system 100 apply to that client system (e.g., the digital datasets correspond to functions or infrastructure of the entity using the client system), with other tenants having other digital datasets, and instances of the software components of the access permission management system 100 described herein may only be available to the client system, with other tenants having access other instances of these software components. In additional or alternative aspects, the access permission management system 100 can be implemented on one or more computing systems operated by a single entity. For instance, the access permission management system 100 (or portions of the access permission management system 100) can be operated on a first server system controlled by the entity (e.g., via an on-premises installation of software components described herein) and can communicate with a second server system that is a client system controlled by the entity.

In some aspects, the server device 1104 supports the access permission management system 100 on the client device 1106. For instance, the server device 1104 generates/maintains the access permission management system 100 and/or one or more components of the access permission management system 100 for the client device 1106. The server device 1104 provides the access permission management system 100 to the client device 1106 (e.g., as a software application/suite). In other words, the client device 1106 obtains (e.g., downloads) the access permission management system 100 from the server device 1104. At this point, the client device 1106 is able to utilize the access permission management system 100 to generate access policies or request access to one or more objects via that access policies independently from the server device 1104.

In alternative aspects, the access permission management system 100 includes a web hosting application that allows the client device 1106 to interact with content and services hosted on the server device 1104. To illustrate, in one or more aspects, the client device 1106 access a web page supported by the server device 1104. The client device 1106 provide input to the server device 1104 to perform data policy administration, and, in response, the access permission management system 100 on the server device 1104 performs operations to eagerly evaluate the access policy. The server device 1104 provides the output or results of the operations to the client device 1106.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media. Non-transitory computer-readable storage media (devices) includes optical and/or non-optical memory, disks, or caches that store computer data interpretable by one or more processors to execute particular functions as described herein. A “network” is defined as one or more data links that enable the transport of electronic data between computer systems and/or modules and/or other electronic devices. Information is transferred or provided over a network (either hardwired, wireless, or a combination of hardwired or wireless) to a computer to carry program code in the form of computer-executable instructions or data structures and which can be accessed by a general purpose or special purpose computer.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code.

Embodiments of the present disclosure can also be implemented in cloud computing environments. In this description, “cloud computing” is defined as a model for enabling on-demand network access to a shared pool of configurable computing resources. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth.

FIG. 12 illustrates, in block diagram form, an example computing device 1200 (e.g., the computing device 1200, the client device(s) 110, and/or the server device(s) 102) that may be configured to perform one or more of the processes described above. As shown by FIG. 12, the computing device can comprise a processor(s) 1202, memory 1204, a storage device 1206, an I/O interface 1208, and a communication interface 1210.

In particular embodiments, processor(s) 1202 includes hardware for executing instructions, such as those making up a computer program. As an example, and not by way of limitation, to execute instructions, processor(s) 1202 may retrieve (or fetch) the instructions from an internal register, an internal cache, memory 1204, or a storage device 1206 and decode and execute them. The computing device 1200 includes memory 1204, which is coupled to the processor(s) 1202. The memory 1204 may be used for storing data, metadata, and programs for execution by the processor(s). The memory 1204 may include one or more of volatile and non-volatile memories. The memory 1204 may be internal or distributed memory. The computing device 1200 includes a storage device 1206 includes storage for storing data or instructions. As an example, and not by way of limitation, storage device 1206 can comprise a non-transitory storage medium described above. The computing device 1200 also includes one or more input or output (“I/O”) devices/interfaces 1208, which are provided to allow a user to provide input to (such as user strokes), receive output from, and otherwise transfer data to and from the computing device 1200. These I/O devices/interfaces 1208 may include a mouse, keypad or a keyboard, a touch screen, camera, optical scanner, network interface, modem, other known I/O devices or a combination of such I/O devices/interfaces 1208.

The computing device 1200 can further include a communication interface 1210. The communication interface 1210 can include hardware, software, or both. The communication interface 1210 can provide one or more interfaces for communication (such as, for example, packet-based communication) between the computing device and one or more other computing devices (e.g., computing device 1200) or one or more networks. The computing device 1200 can further include a bus 1212. The bus 1212 can comprise hardware, software, or both that couples components of computing device 1200 to each other.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A computer-implemented method comprising:
generating, by one or more hardware processors and for storing at a tenant database associated with a tenant in a multi-tenant environment, mapping records for one or more user accounts and one or more objects by executing an eager evaluation model on a set of rules in response to a creation of an access policy to:
generate one or more policy subject mappings that maps the access policy to the one or more user accounts according to attributes of the one or more user accounts; and
generate one or more policy object mappings that maps the access policy to the one or more objects according to attributes of the one or more objects;
receiving, by the one or more hardware processors, a request for access to the one or more objects within the tenant database from a user account of the one or more user accounts in connection with the access policy; and
providing, by the one or more hardware processors accessing the mapping records at the tenant database, access to the one or more objects for the user account based on the one or more policy subject mappings, the one or more policy object mappings, and one or more attributes of the user account.

2. The computer-implemented method of claim 1, further comprising:
detecting, by the one or more hardware processors, a change to the one or more objects or the one or more user accounts;
detecting, utilizing the eager evaluation model, an access policy change to the access policy based on the change to at least the one or more objects within the tenant database or the one or more user accounts associated with the tenant; and
updating, by executing the eager evaluation model, the one or more policy subject mappings or the one or more policy object mappings based on the access policy change.

3. The computer-implemented method of claim 1, further comprising:
associating one or more permissions with the access policy, the one or more attributes of the user account, and the one or more attributes of an object of the one or more objects; and
providing access to the one or more permissions based on the access policy, the one or more attributes of the user account, and the one or more attributes of the object.

4. The computer-implemented method of claim 1, further comprising:
determining, by the one or more hardware processors, an exclusionary access policy corresponding to a subset of user accounts of the one or more user accounts and a subset of objects from the one or more objects; and
denying, by the one or more hardware processors accessing the mapping records within the tenant database, the subset of user accounts access to the subset of objects based on the exclusionary access policy.

5. The computer-implemented method of claim 1, further comprising:
generating a tenant context corresponding to the tenant database based on one or more attributes of the one or more user accounts associated with the tenant;
determining the tenant context based on the user account associated with the request for access to the one or more objects within the tenant database; and
connecting the one or more hardware processors to the tenant database based on the tenant context.

6. The computer-implemented method of claim 1, further comprising:
detecting, by the one or more hardware processors, a creation of an additional access policy; and
in response to the creation of the additional access policy, generating:
one or more additional policy subject mappings that maps the additional access policy to the one or more user accounts; and
one or more additional policy object mappings that maps the additional access policy to the one or more objects.

7. The computer-implemented method of claim 1, further comprising:
receiving, from an administrative user account associated with the tenant, shared direct access of an object from the one or more objects with a user account from the one or more user accounts.

8. A system comprising:
one or more non-transitory computer readable media; and
processing hardware configured to cause the system to:
generate, via an access policy administration server linked to a tenant database associated with a tenant in a multi-tenant environment, mapping records for one or more user accounts and one or more objects by executing an eager evaluation model on a set of rules in response to a creation of an access policy to link the one or more user accounts to the one or more objects to the access policy via mappings to the access policy;
receive, via an access policy enforcement server, a request for access to the one or more objects within the tenant database from a user account of the one or more user accounts in connection with the access policy;
determine, via an access policy decision server linked to the tenant database and communicating with the access policy administration server, access for the user account based on the mappings to the access policy and one or more attributes of the user account; and
provide, via the access policy enforcement server communicating with the access policy decision server, access to the one or more objects within the tenant database for the user account based on the access for the user account.

9. The system of claim 8, wherein the processing hardware is further configured to cause the system to generate the mappings to the access policy by:
based on the creation of the access policy, receiving, via the access policy administration server linked to an object management microservice an access policy message corresponding to the access policy,
generating, via the object management microservice linked to an access policy modification component of the access policy decision server, an indirect access control list (ACL) based on evaluating the access policy; and
receiving, via the access policy modification component, the indirect ACL to store in the access policy decision server and the tenant database for storage.

10. The system of claim 8, wherein the processing hardware is further configured to cause the system to:
detect, via an access policy modification component of the access policy decision server, one or more changes to the access policy based on one or more changes to the one or more objects;
generate an updated indirect access control list (ACL), based on the one or more changes to the access policy; and
receive, via the access policy modification component communicating with the access policy decision server, the updated indirect access control list.

11. The system of claim 8, wherein the processing hardware is further configured to cause the system to:
receive, from a client device associated with the user account, a request query to access a plurality of objects associated with the user account;
generate a structured query language (SQL) function comprising an access control check corresponding to the access policy; and
provide access to the plurality of objects for the user account based on the access control check.

12. The system of claim 8, wherein the processing hardware is further configured to cause the system to:
receive, from a client device associated with the user account, a request query to access an object from the one or more objects; and
based on the request query, send a request to the access policy decision server via the access policy enforcement server to determine access of the object from the user account.

13. The system of claim 8, wherein the processing hardware is further configured to cause the system to:
receive, from a client device associated with an administrative user account, an indication of shared direct access to an object from the one or more objects for a user account;
generate a direct share ACL for the object based on the shared direct access; and
provide access of the object to the user account based on the direct share ACL.

14. The system of claim 8, wherein the processing hardware is further configured to cause the system to:
generate a tenant context corresponding to the tenant database based on one or more attributes of the one or more user accounts associated with the tenant;
determine the tenant context based on the user account associated with the request for access to the one or more objects within the tenant database; and
connect the access policy administration server, the access policy enforcement server, and the access policy decision server to the tenant database based on the tenant context.

15. A non-transitory computer readable medium comprising instructions that, when executed by at least one computer processor, cause the at least one computer processor to:
detect a creation of an access policy comprising a set of rules;
generate, by executing an eager evaluation model on the set of rules in response to the creation of an access policy:
a policy subject mapping that maps the access policy to a user account according to one or more attributes of the user account; and
a policy object mapping that maps the access policy to an object according to one or more attributes of the object;
receive a request for access to the object within a tenant database associated with a tenant from a user account of one or more user accounts in connection with the access policy; and
provide access to the object for the user account based on the policy subject mapping, the policy object mapping, and the one or more attributes of the user account.

16. The non-transitory computer readable medium of claim 15, further comprising instructions that, when executed by the at least one computer processor, cause the at least one computer processor to:
detect a deletion or an addition of an object of one or more objects or a user account of the one or more user accounts in connection with the tenant;
detect an access policy change to the access policy based on the deletion or the addition of the object within the tenant database or the user account in connection with the tenant; and
update the policy subject mapping or the policy object mapping based on the access policy change.

17. The non-transitory computer readable medium of claim 15, further comprising instructions that, when executed by the at least one computer processor, cause the at least one computer processor to:
associate one or more permissions with the access policy, the one or more attributes of the user account, and the one or more attributes of the object, wherein the one or more permissions comprise reading, editing, or approving the object; and
provide access to the one or more permissions based on the access policy, the one or more attributes of the user account, and the one or more attributes of the object.

18. The non-transitory computer readable medium of claim 15, further comprising instructions that, when executed by the at least one computer processor, cause the at least one computer processor to:
identify one or more attributes of the user account associated with the tenant; and
generate, by executing the eager evaluation model, the policy subject mapping based on the one or more attributes of the user account.

19. The non-transitory computer readable medium of claim 15, further comprising instructions that, when executed by the at least one computer processor, cause the at least one computer processor to:
identify one or more attributes of the object within the tenant database; and
generate, by executing the eager evaluation model, the policy object mapping based on the one or more attributes of the object.

20. The non-transitory computer readable medium of claim 15, further comprising instructions that, when executed by the at least one computer processor, cause the at least one computer processor to:
receive, from a client device associated with an administrative user account associated with the tenant, an indication of a shared direct revocation of access to an object from one or more objects within the tenant database for the user account from the one or more user accounts associated with the tenant; and
revoke access to the object for the user account based on the shared direct revocation of access.
